(19) United States
(12) Patent Application Publication
(10) Pub. No.: US 2025/0351775 A1
(43) Pub. Date: Nov. 20, 2025

(54) ATTACHABLE MESH ULTRAVIOLET AND OUTDOOR ELEMENT PROTECTION DEVICE FOR RIDING MOWERS

(71) Applicants: Josh Ray Enochs, Newbern, TN (US); Carlton Ray Enochs, Newbern, TN (US); Chad Enochs, Newbern, TN (US)

(72) Inventors: Josh Ray Enochs, Newbern, TN (US); Carlton Ray Enochs, Newbern, TN (US); Chad Enochs, Newbern, TN (US)

(21) Appl. No.: 18/667,060

(22) Filed: May 17, 2024

(51) Int. Cl. A01D 75/20; A01D 101/00

(52) U.S. Cl. CPC A01D 75/20; A01D 2101/00

(57) ABSTRACT

An outdoor element barrier removably attachable to a riding mower for shielding the rider from direct sunlight, flying debris such as mulched up grass and leaves blowing out of the mower, and other outdoor elements and pests. The riding mower barrier includes a front netting shield and a solid upper canopy portion dimensioned and adapted to protect the rider from flying debris and sun, respectively. Side and rear mesh netting may also be supported by the present invention, thereby defining an enclosure about the upper surface of nearly the entire riding mower.

### BACKGROUND OF THE INVENTION

The present invention relates to riding mowers and, more particularly, to an attachable mesh ultraviolet (UV) and outdoor element protection device and system for riding mowers.

A riding mower, also known as a ride-on mower, tractor mower or lawn tractor, is a type of lawn mower on which the operator is seated, unlike mowers which are pushed or towed.

While riding a mower, the rider is exposed to UV rays, outdoor elements, and debris resulting from the mowing process, such as dust, grass, and leaves. This results in the rider suffering from potential sunburns, allergic reactions along with being dirty when the mowing is complete.

There are no known easily attachable devices that shield and protect a mower rider from these elements.

As can be seen, there is a need for an attachable outdoor element protection device for riding mowers.

### SUMMARY OF THE INVENTION

The device embodied in the present invention is dimensioned and adapted to removably attach to the riding mower so as to shield the rider with front, rear and side netting and a solid upper canopy to not only protect the rider from flying debris such as mulched up grass and leaves blowing out of the mower but also the sun.

In one aspect of the present invention, a barrier system for a riding mower, the barrier system includes the following: a framing extending from a front attachment point of the riding mower to a rear attachment point of the riding mower; a netting barrier connected along a front portion of the framing; and a canopy cover connected along a rear portion of the framing, wherein the front portion is substantially vertical, and the rear portion is approximately horizontal, and wherein attachment of a distal portion of the canopy cover urges the framing to be substantially vertical along its front portion, wherein the front portion and the rear portion are separated by an inflection point of the framing, wherein the distal portion of the canopy is forward the inflection point, and wherein the inflection point is forward a riding seat of the riding mower.

In another aspect of the present invention, the barrier system disclosed herein further including wherein framing comprises two spaced apart flexible rods, wherein each attachment point has a clamp operatively associable to a structural component of the riding mower; and a rod engager for engaging a portion of the supporting rod, wherein the rod engager is fixed to the clamp; further including straps along each supporting rod to engage longitudinal edges of the netting barrier; further including a tension member interconnecting the two spaced apart supporting rods adjacent to an upper edge of the netting barrier; further including an access port along the netting barrier; and further including two side mesh nettings and a rear mesh netting that define, along with the netting barrier and canopy cover, an enclosure around a riding seat of the riding mower.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention.

FIG. 2 is a detailed perspective view of an exemplary embodiment of the present invention taken along line 2-2 in FIG. 1, illustrating front clamp hardware 22A and 22B defining attachment points along the front of the riding mower 11.

FIG. 3 is a detailed perspective view of FIG. 2, from another vantage point to further illustrate the front clamp hardware 22A and 22B operatively associating a distal end of a support rod 16 with the front of the riding mower 11. The netting shield 18 and strapping 20A are not shown for clarity.

FIG. 4 is a detail perspective view of an exemplary embodiment of the present invention, illustrating an operatively association of proximal ends of the support rods 16 to the roll bar 24 along the rear of the riding mower 11 by way of rear clamp hardware 22A and 22C.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

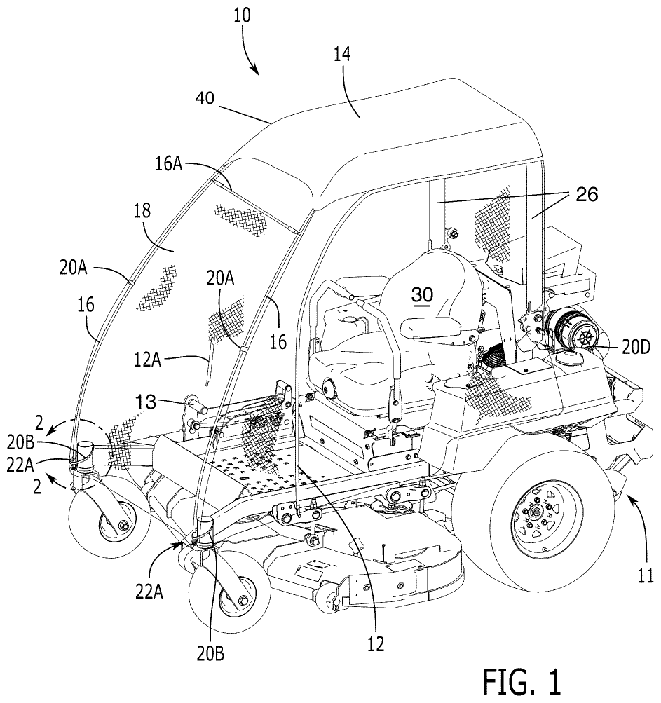

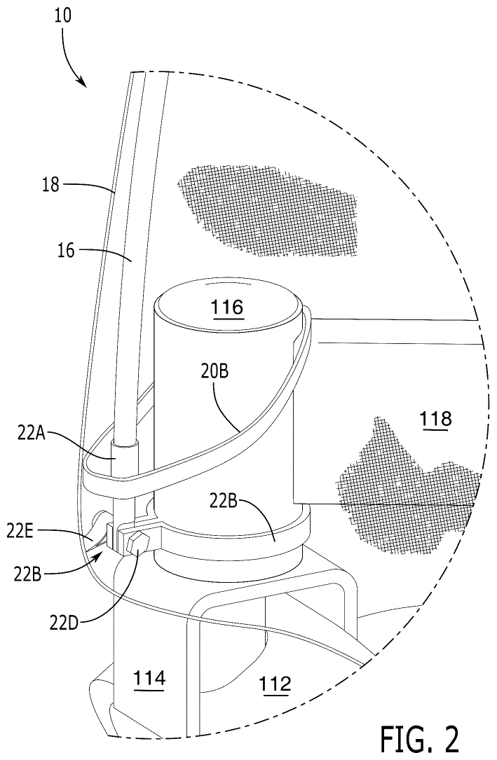

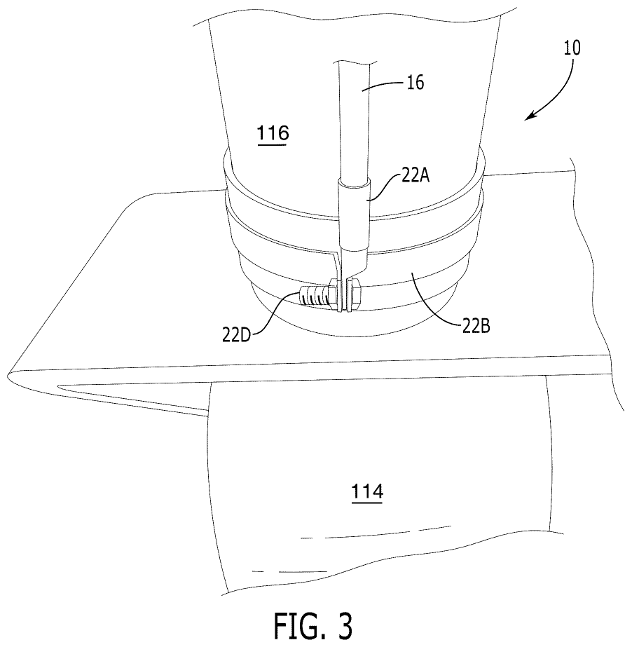

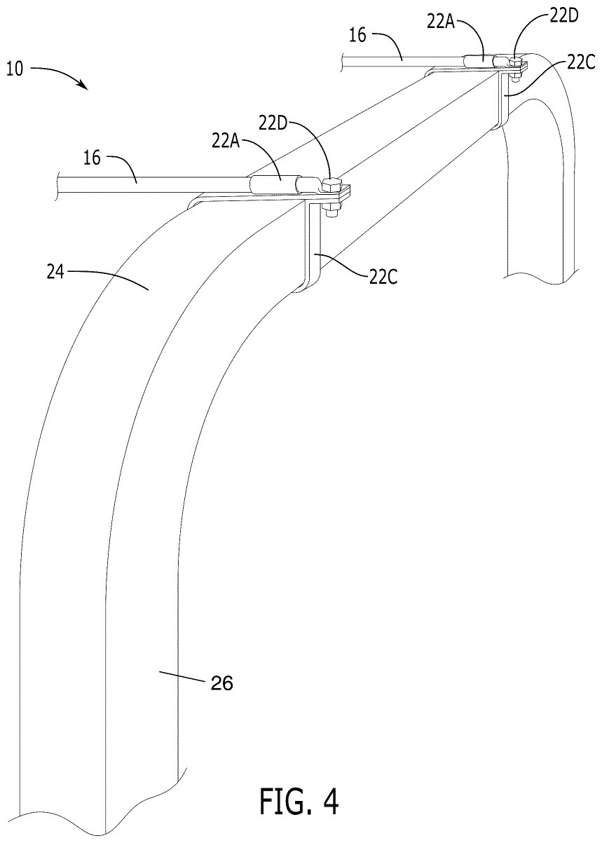

Referring to FIGS. 1 through 4, the present invention discloses a removably attachable riding mower barrier 10 for multifunctional protection of the rider of a riding mower 11. Riding mowers 11, which sometimes resemble small tractors, and so share certain components such as a roll bar 24 disposed immediately behind and upward of the rider seat 30, wherein the roll bar 24 is supported by columns 26 similarly disposed immediately behind the rider seat 30. Likewise, a riding mower 11 typically has two front caster tires 112 engaged by a yoke 114, wherein a bearing housing 116 contains bearings for enabling the independent swivel functionality of the two front caster tires 112, and wherein a crossmember 118 interconnects the two front caster tires 112.

The riding mower barrier 10 may be embodied in a device, a system, and a method. Riding mower barrier 10 may include a netting shield 18 and a canopy cover 14. The netting shield 18 is disposed at least forward of the rider seat 30 for filtering out debris or pests that are urged toward the rider because of forward motion of the riding mower 11, while the canopy cover 14 is disposed upward of the rider seat 30 for protecting a rider from directly sunlight. In other embodiments, side and rear mesh netting is provided to define a complete enclosure along almost the entire upper surface of riding mower 11.

The netting shield 18 is supported in a substantially vertical orientation (relative to the ground supporting the riding mower 11) by framing elements that include, but are not limited to, two spaced apart support rods 16. The supporting rods 16 may be made from fiberglass or other flexible, bending-resilient material. Each support rod 16 is connected at the front and rear portions to the riding mower 11. A forward or distal end of the support rods 16 may be connected to the bearing housing 116 (or other structural component—e.g., wheel spindles or deck frame) of one the two front caster tires 112, while a rearward or proximal end of the support rods 16 may be connected to the roll bar 24.

The distal end of each support rod 16 may be connected to structure associated with the front frame or caster tires of the riding mower 11 by way of a front clamp 22B. The front clamp 22B may be operatively associated with a structural component of the riding mower 11, such as the bearing housing 116. In one embodiment, the front clamp 22B may be an arcuate collar that is clamped around the cylindrical housing 116 and fastened by way of fasteners 22D, 22E. A rod engager 22A may be connected to the front clamp 22B, wherein the rod engager 22A receives or otherwise engages the distal end of the supporting rod 16. A strap 20B may interconnect the structural components of riding mower 11 with a portion of the rod engager 22A and/or the front clamp 22B.

The proximal end of each support rod 16 may be connected to the roll bar 24 by way of a rear clamp 22C that is clamped around the roll bar 24 and fastened by way of a fastener 22D. Another rod engager 22A may be connected to the rear clamp 22C, wherein the rod engager 22A receives or otherwise engages the proximal end of the supporting rod 16.

When so clamped or fixed at both ends, especially if properly dimensioned, each supporting rod 16 arches as it extends from its distal and to its proximal end, whereby the forward portion of the supporting rod 16 is substantially vertical along this forward portion, with a rearward lean, as illustrated in FIG. 1. The netting shield 18 spans the two spaced apart supporting rods 16 along this forward portion. Along the length of each forward portion of the support rods 16 one or more securing straps 20A may interconnect the netting shield 18 to the support rod 16, thereby keeping the netting shield 18 taught and otherwise supported at a multitude of attachment points along the length of the netting shield 18. Furthermore, a tension rod 16A may interconnect the two spaced apart support rods 16 adjacent to an upper edge of the netting shield 18 for supplying similar support to said upper edge.

The canopy cover 14 may extend the two spaced apart support rods 16 as well as engage the roll bar 24. The canopy cover 14 may extend forwardly to adjacent the tension rod 16A. A distance of the adjacency may be between zero and twelve inches, wherein this adjacency or proximity is critical to facilitating and thus locating the inflection point 40 of the supporting rods 16 as shown in FIG. 1, which in turn allows for their substantially vertical front portion and substantially horizontal rear portion, wherein that inflection point 40 is between the caster tires 112 and the riding seat 30. In some embodiments, rear mesh netting may extend between the columns 26 of the roll bar 24, while side mesh netting may extend along each side of the riding mower 11, wherein the side mesh netting is supported along each support rod 16 and operatively associated one or more securing straps 20A. A rearward edge of the side mesh netting may be supported along a rearward edge by way of the columns 26 of the roll bar 24. An upper edge of the side mesh netting may be supported by the canopy cover 14. Thereby, the netting shield 18, mesh nettings, and canopy cover 14 define an enclosure around the riding seat 30. The enclosure may provide an entryway 12 along one or both side mesh nettings. Entryway 12 may have a detachable attachment, such as a zipper, hook and pile fasteners, or the like to enable selectively positioning of the entryway 12 between a closed position to an open position.

Both the forward and rear clamps 22B and 22C can be pre-installed onto riding mower 11 before the supporting rods 16 and netting shield 18 and mesh netting are attached. The netting shield 18 may be slid onto the supporting rods 16 using sewn in loops or straps 20A. Each end of the supporting rods 16 is then inserted into the rod engager 22A mounting points. The straps 20A that may be sewn into the netting shield 18/mesh nettings are then looped around the mounting points to pull them tight. A cross brace or tension member 16A may be attached between the two supporting rods 16 to ensure stability, as previously discussed. While the side entryway 12 may be used to gain access to the enclosure defined by the barrier 10 and the riding mower 11, a front access port 12A, disposed along the netting shield 18 with its own sewn-in detachable fastener, may be used to gain access to the deck cover handle 13 that is standard on many mowers 11.

As used in this application, the term “about” or “approximately” refers to a range of values within plus or minus 10% of the specified number. And the term “substantially” refers to up to 80% or more of an entirety. In the case of ‘substantially vertical’ front portion of the supporting rod 16, it is understood that the supporting rod 16 is oriented normal to a supporting surface of the riding mower 11 but for a twenty percent deviation from normal—e.g., when drawing a straight line (even though the front portion is understood to be curved during use) from the distal end to the inflection point 40 an angle between ninety and seventy-two degrees is realized). Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A barrier system for a riding mower, the barrier system comprising:
a framing extending from a front attachment point of the riding mower to a rear attachment point of the riding mower;
a netting barrier connected along a front portion of the framing; and
a canopy cover connected along a rear portion of the framing,
wherein the front portion is substantially vertical, and the rear portion is approximately horizontal, and wherein attachment of a distal portion of the canopy cover urges the framing to be substantially vertical along its front portion.

2. The barrier system of claim 1, wherein the front portion and the rear portion are separated by an inflection point of the framing, wherein the distal portion of the canopy is forward the inflection point, and wherein the inflection point is forward a riding seat of the riding mower.

3. The barrier system of claim 1, wherein framing comprises two spaced apart flexible rods.

4. The barrier system of claim 3, wherein each attachment point comprises:
a clamp operatively associable to a structural component of the riding mower; and
a rod engager for engaging a portion of the supporting rod, wherein the rod engager is fixed to the clamp.

5. The barrier system of claim 4, further comprising straps along each supporting rod to engage longitudinal edges of the netting barrier.

6. The barrier system of claim 5, further comprising a tension member interconnecting the two spaced apart supporting rods adjacent to an upper edge of the netting barrier.

7. The barrier system of claim 6, further comprising an access port along the netting barrier.

8. The barrier system of claim 7, further comprising two side mesh nettings and a rear mesh netting that define, along with the netting barrier and canopy cover, an enclosure around a riding seat of the riding mower.
